(19) United States
(12) Patent Application Publication
(10) Pub. No.: US 2009/0277009 A1
(43) Pub. Date: Nov. 12, 2009

(54) Method for manufacturing and/or machining components

(75) Inventors: Thorben Kotzbacher, Muenchen (DE); Erich Steinhardt, Muenchen (DE)

Correspondence Address: CROWELL & MORING LLP;INTELLECTUAL PROPERTY GROUP, P.O. BOX 14300, WASHINGTON, DC, 20044-4300, US

(73) Assignee: MTU AERO ENGINES, Munich (DE)

(21) Appl. No.: 10/585,436

(22) PCT Filed: Dec. 21, 2004
(86) PCT No.: PCT/DE04/02780

§ 371 Date: Jun. 30, 2009

(30) Foreign Application Priority Data
Jan. 9, 2004 (DE) 10-2004-394.2

(51) Int. Cl. B23P 15/04; B23Q 11/00

(52) U.S. Cl. 29/889.2; 409/131

(57) ABSTRACT

A method for manufacturing and/or machining components, in particular gas turbine components such as blades, blade segments or integrally bladed rotors for an aircraft engine, is disclosed. In an embodiment, the method for manufacturing components, in particular gas turbine components, includes at least the following steps: a) providing a workpiece; b) milling the workpiece to provide a component to be manufactured; c) rounding the edges of the component and/or smoothing the surface of the component and/or hardening the surface of the component by a hydraulic method using a lubricant and/or coolant required for the milling.

### BACKGROUND AND SUMMARY OF THE INVENTION

This application claims the priority of International Application No. PCT/DE2004/002780, filed Dec. 21, 2004, and German Patent Document No. 10 2004 001 394.2, filed Jan. 9, 2004, the disclosures of which are expressly incorporated by reference herein.

The present invention relates to a method for manufacturing and/or machining components, in particular gas turbine components.

Modern gas turbines, in particular aircraft engines, must meet extremely high demands with regard to reliability, weight, power, economy and lifetime. In recent decades, aircraft engines that fully meet all the requirements listed above and have achieved a high level of technical perfection have been developed, especially in the civilian sector. The choice of materials, the search for suitable novel materials and novel production methods, among other things, have played a decisive role in the development of aircraft engines.

The most important materials used for aircraft engines or other gas turbines today are titanium alloys, nickel alloys (also known as superalloys) and high-strength steels. The high-strength steels are used for shaft parts, gear parts, compressor housings and turbine housings. Titanium alloys are the typical materials for compressor parts. Nickel alloys are suitable for the hot parts of an aircraft engine.

Precision casting and forging are the main production methods known from the state of the art as production methods for gas turbine parts made of titanium alloys, nickel alloys or other alloys. All high-stress gas turbine components such as the blades for a compressor are forged parts. However, the rotor blades and guide vanes of the turbine are usually designed as precision cast parts. Integrally bladed rotors such as blisks (bladed disks) or blings (bladed rings) may be manufactured by milling from a solid blank according to the state of the art. Milling from a solid blank is used mainly in the manufacture of blisks or blings from titanium materials. Milling of integrally bladed rotors from nickel materials is problematical because of the poor machinability of the nickel material.

If integrally bladed rotors made of a workpiece are milled from a solid blank, then the milling is usually followed by surface machining of the milled gas turbine component, preferably by surface hardening and/or surface strengthening, surface smoothing and optionally rounding of edges. Such surface machining may also be performed on precision cast parts or forged parts.

According to the state of the art, it is customary to perform the milling on a milling machine and to perform the surface strengthening and surface smoothing by means of particle bombardment on separate machines and to perform the edge rounding by manual grinding. According to the state of the art, a separate production machine is thus used for each manufacturing step and/or machining step. After performing a production step and for the execution of a subsequent production step, the workpiece and/or the gas turbine component must then be arranged on a new production machine. Repeated changing of production machines is time consuming.

Against this background, the object of the present invention is to propose a novel method for manufacturing and/or machining components, in particular gas turbine components.

The inventive method for manufacturing components, in particular gas turbine components such as blades, blade segments or integrally bladed rotors for an aircraft engine, includes at least the following steps: a) providing a workpiece; b) milling the workpiece to provide a component to be manufactured; c) rounding the edges of the component and/or smoothing the surface of the component and/or hardening the surface of the component by hydraulic methods using a lubricant and/or a coolant required for milling.

According to the inventive method for machining components, in particular gas turbine components such as blades, blade segments or integrally bladed rotors for an aircraft engine, the component is subjected to a surface hardening and/or a surface smoothing and/or an edge rounding, each performed by a hydraulic method using a fluid, in particular using water or oil.

Preferred refinements of the invention are derived from the following description, which is based on the preferred application, namely the machining or manufacture of gas turbine components.

### DETAILED DESCRIPTION OF THE EXEMPLARY EMBODIMENTS

In the inventive method for machining gas turbine components, in particular blades, blade segments or integrally bladed rotors for an aircraft engine, the gas turbine component is subjected to a surface hardening and/or a surface smoothing and/or an edge rounding, whereby the surface hardening and the surface smoothing and the edge rounding are each performed by a hydraulic method using a fluid. The fluid used may be water or oil in particular. According to the invention, the surface hardening and/or surface smoothing and/or the edge rounding is/are performed on the same machine using the same fluid. The component may thus remain on one machine for a wide variety of machining steps and/or manufacturing steps to be performed. This greatly reduces the machining time and/or the production time.

In the inventive method for manufacturing gas turbine components, preferably of integrally bladed rotors, an integrally bladed rotor is milled on a milling machine from a workpiece provided from a solid blank. The surface hardening and/or the surface smoothing and/or the edge rounding of the integrally bladed rotor milled out of the workpiece after milling is/are then performed within the scope of the present invention directly on the milling machine using a lubricant and/or coolant required for milling. The drilling oil emulsion needed for milling is thus used for surface hardening and surface smoothing and edge rounding.

It is thus within the scope of the present invention to perform at least the surface hardening and/or surface smoothing and edge rounding in the manufacture and/or machining of gas turbine components such as integrally bladed rotors on one machine in combination with a hydraulic method.

According to an advantageous embodiment of the inventive method for machining and/or manufacturing gas turbine components, an impact pressure and/or an impact direction and/or an impact area and/or an impact speed of the fluid used is adapted for the surface hardening and surface smoothing and edge rounding. The impact area of the fluid may be influenced by adjusting the diameter of a stream of fluid directed at the gas turbine component. To vary the direction of impact, nozzles used to create the fluid stream may be directed at different angles onto the surface of the gas turbine component to be machined, in particular onto a blade surface to be machined. A defined surface machining may be performed by varying the impact pressure and/or the impact direction and/or the impact area and/or the impact speed of the fluid stream.

It is within the scope of the present invention to monitor the above parameters during surface hardening and surface smoothing and edge rounding online and to control and/or regulate the machining and/or manufacturing as a function thereof. To do so, measuring instruments and/or sensors are used, continuously measuring the above parameters and/or measuring quantities depending thereon and transmitting the measuring signals to a regulating device for continuous adjustment of the machining processes and/or the manufacturing processes.

With the help of the present invention, the machining and/or manufacture of gas turbine components, in particular blades, blade segments and integrally bladed rotors, can definitely be simplified and improved. Reproducible results can be obtained by eliminating manual machining steps. The machining time and/or production time can be greatly reduced by combining several machining steps on one machine.

1-9. (canceled)

10. A method for manufacturing gas turbine components, in particular blades, blade segments or integrally bladed rotors for an aircraft engine, wherein a workpiece is provided, the workpiece being milled to provide a component for manufacturing, the component then being machined by a hydraulic method using a lubricant and/or coolant required for milling, wherein following the milling, the component milled out of the workpiece is subjected to a surface hardening, and then following the surface hardening, it is subjected to a surface smoothing, each using the lubricant and/or coolant required for milling.

11. The method according to claim 10, wherein the component is subjected to edge rounding after the surface smoothing, wherein the edge rounding uses the lubricant and/or coolant needed for milling.

12. The method according to claim 11, wherein a drilling oil emulsion used for the milling is also used for the surface hardening and/or for the surface smoothing and/or for the edge rounding.

13. The method according to claim 10, wherein the milling and the surface hardening and/or the surface smoothing and/or the edge rounding is/are performed on a same machine.

14. The method according to claim 13, wherein the machine is a milling machine.

15. The method according to claim 11, wherein a pressure and/or an impact direction and/or an impact area of the lubricant and/or coolant is/are adjusted to the component for the surface hardening and/or for the surface smoothing and/or for the edge rounding.

16. A method for machining gas turbine components, in particular blades, blade segments or integrally bladed rotors for an aircraft engine, wherein the component is machined by a hydraulic method using a fluid, in particular using water or oil, wherein the component is subjected to a surface hardening, and then following the surface hardening, it is subjected to a surface smoothing, each using the same fluid.

17. The method according to claim 16, wherein following the surface hardening, the component is subjected to edge rounding, likewise using the same fluid.

18. The method according to claim 17, wherein the surface hardening and/or the surface smoothing and/or the edge rounding is/are performed on a same machine.

19. The method according to claim 17, wherein a pressure and/or an impact direction and/or an impact area of the fluid is/are adjusted to the component for the surface hardening and/or for the surface smoothing and/or for the edge rounding.

20. A method for manufacturing a gas turbine component, comprising the steps of:
milling a workpiece on a milling machine to form the gas turbine component, wherein a fluid is used in the milling step;
surface hardening the gas turbine component on the milling machine by using the fluid; and
surface smoothing the gas turbine component on the milling machine by using the fluid.

21. The method according to claim 20, further comprising the step of edge rounding the gas turbine component on the milling machine by using the fluid.

22. The method according to claim 20, wherein the gas turbine component is one of a blade, a blade segment, or an integrally bladed rotor of an aircraft engine.

23. The method according to claim 20, wherein the fluid is a drilling oil emulsion.

24. A method for machining a gas turbine component, comprising the steps of:
surface hardening the gas turbine component by a hydraulic method using a fluid; and
surface smoothing the gas turbine component by using the fluid.

25. The method according to claim 24, further comprising the step of edge rounding the gas turbine component by using the fluid.

26. The method according to claim 24, wherein the gas turbine component is one of a blade, a blade segment, or an integrally bladed rotor of an aircraft engine.

27. The method according to claim 24, wherein the fluid is water.

28. The method according to claim 24, wherein the fluid is an oil.

29. The method according to claim 25, wherein the steps of surface hardening, surface smoothing, and edge rounding are performed on a same machine.
